(19) United States
(12) Patent Application Publication
(10) Pub. No.: US 2004/0115096 A1
(43) Pub. Date: Jun. 17, 2004

(54) Stopper for tube-shaped specimen containers

(76) Inventor: Teruaki Itoh, Kumamoto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/730,917

(22) Filed: Dec. 10, 2003

(30) Foreign Application Priority Data
Dec. 10, 2002 (JP) 2002-358529

(51) Int. Cl. B01L 3/00

(52) U.S. Cl. 422/99

(57) ABSTRACT

A stopper for tube-shaped specimen containers includes an inserting section that is pushed into an opening of a tube-shaped specimen container, a closing section that continues with the inserting section and has a flat surface that is brought into intimate contact with a rim of the opening, and an operating section that continues with the closing section and operates to insert/remove the inserting section into/from the opening. In the stopper, the inserting section is formed of an elastically deformable liquid-tight member, and an annular flange section is projected from an outer surface of a cylindrical body such that a periphery of the annular flange section is liquid-tightly pressed on an inner surface of the opening of the tube-shaped specimen container.

### CROSS-REFERENCE TO RELATED APPLICATIONS

This application is based upon and claims the benefit of priority from the prior Japanese Patent Application No. 2002-358529, filed Dec. 10, 2002, the entire contents of which are incorporated herein by reference.

### BACKGROUND OF THE INVENTION

1. Field of the Invention

The present invention relates to a stopper for closing an opening of a tube-shaped specimen container that is typified by a so-called test tube containing a specimen such as blood and urine.

2. Description of the Related Art

When a tube-shaped specimen container containing a specimen such as blood and urine is stored, its opening is hermetically sealed with a stopper in order to prevent the specimen from evaporating and prevent foreign matter from coming into the container from outside. Specimen containers of different sizes are used according to their own applications as tube-shaped specimen containers, especially specimen containers used for testing specimens. Stoppers of different sizes are prepared for the specimen containers of different sizes.

Jpn. Pat. Appln. KOKAI Publication No. 2001-158450 discloses a stopper for a test tube serving as a specimen container as a prior art one as described above. The stopper has a columnar press-in section that is detachably inserted into the opening of the test tube. The columnar press-in section has a smooth outer surface. Thus, the outside diameter of the press-in section has to be perfectly consistent with the inside diameter of the opening of the test tube.

For example, a stopper whose press-in section has an outside diameter of 11 mm cannot be inserted into a test tube whose opening has an inside diameter of, e.g., 10 mm. Conversely, a stopper whose press-in section has an outside diameter of 10 mm is inserted very loosely into a test tube whose opening has an inside diameter of, e.g., 11 mm. Consequently, the opening of the test tube cannot be sealed sufficiently hermetically. There is a fear that a specimen will evaporate and in extreme cases, the stopper will be removed from the specimen container.

### BRIEF SUMMARY OF THE INVENTION

An object of the present invention is to provide a stopper for tube-shaped specimen containers having the following advantages.

1) The stopper can be used in common to a plurality of types of tube-shaped specimen containers whose openings have different inside diameters.

2) The stopper is simple to configure and easy to manufacture.

In order to attain the above object, a stopper for tube-shaped specimen containers according to the present invention has the following characteristic configuration. The other characteristic configurations will be clarified in the embodiment.

A stopper for tube-shaped specimen containers comprises an inserting section that is pushed into an opening of a tube-shaped specimen container, a closing section that continues with the inserting section and has a flat surface that is brought into intimate contact with a rim of the opening, and an operating section that continues with the closing section and operates to insert/remove the inserting section into/from the opening, wherein the inserting section is formed of an elastically-deformable liquid-tight member, and an annular flange section is projected from an outer surface of a cylindrical body such that a periphery of the annular flange section is liquid-tightly pressed on an inner surface of the opening of the tube-shaped specimen container.

### BRIEF DESCRIPTION OF THE SEVERAL VIEWS OF THE DRAWING

FIG. 1 is a side view of a stopper according to an embodiment of the present invention, which is applied to a tube-shaped specimen container.

FIG. 2 is a side view of the stopper according to the embodiment of the present invention, the left side of which is cut away.

FIG. 3 is an end view of the stopper according to the embodiment of the present invention, which is viewed from the insertion end of the specimen container.

FIG. 4 is a plan view of the stopper according to the embodiment of the present invention, which is viewed from the concave side of an annular flange of the stopper.

FIG. 5 is a sectional view taken along line 5-5 of FIG. 4.

### DETAILED DESCRIPTION OF THE INVENTION

(Embodiment)

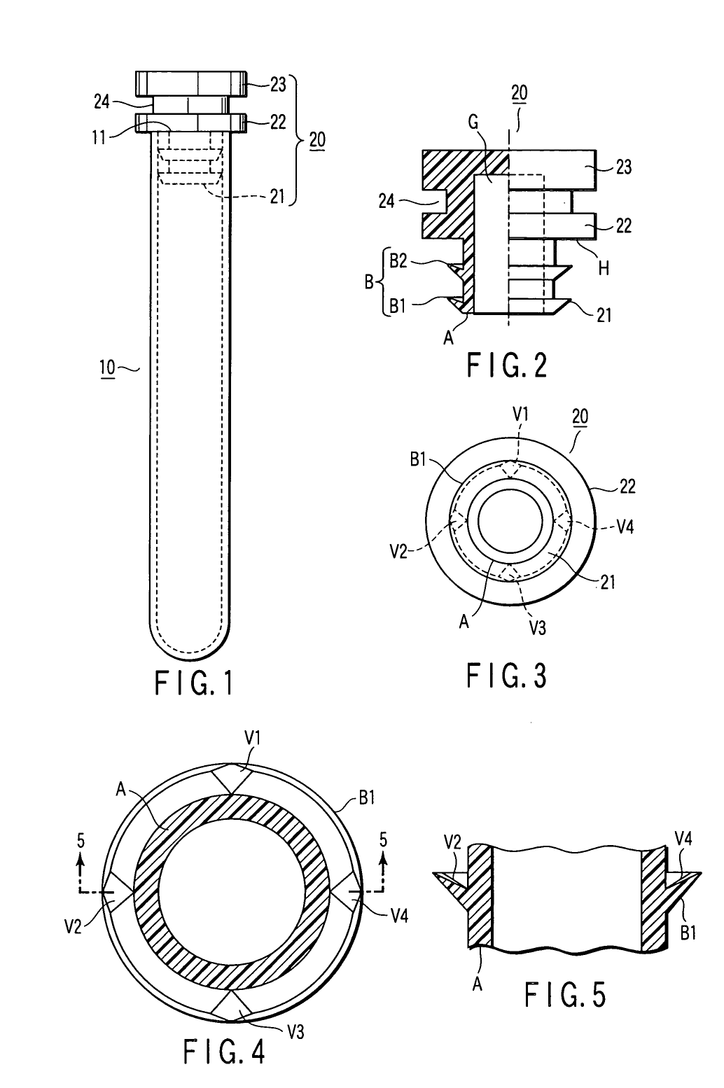

FIGS. 1 to 5 illustrate a tube-shaped specimen container 10. The specimen container 10 is a so-called test tube whose opening 11 has a regular-sized inside diameter of, e.g., about 10 mm. A stopper 20 is fitted into the opening 11 of the specimen container 10 to seal the opening hermetically.

The stopper 20 is formed of a liquid-tight member that can be at least elastically deformed, such as polypropylene resin. The stopper 20 includes an inserting section 21, a disk-shaped closing section 22 and a disk-shaped operating section 23. The inserting section 21 is pushed into the opening 11 of the tube-shaped specimen container 10. The closing section 22 continues with the inserting section 21 and has a flat surface H that can be brought into intimate contact with the rim of the opening 11. The operating section 23 continues with the closing section 22 and operates to insert/remove the inserting section 21 into/from the opening 11. An annular groove 24 is formed between the closing and operating sections 22 and 23 to easily pick up the operating section 23.

The inserting section 21 includes a cylindrical body A having a hollow G inside. Two annular flange sections B (B1, B2) are formed on the outer surface of the cylindrical body A at a fixed interval in the axial direction of the cylindrical body A. Each of the annular flange sections B (B1, B2) is shaped like a parabolic antenna and its insertion end (lower end in FIG. 2) is tapered. The thickness of each flange section B (B1, B2) is set to about 0.55 mm to 0.75 mm (favorably 0.65 mm) such that it can be deformed sufficiently elastically. A plurality of (four in this embodiment) notches V1 to V4 are formed in the concave side of each flange section B (B1, B2) at 90-degree intervals in the circumferential direction such that the outside diameter of each flange section can relatively easily be varied by the surrounding compressive force when the inserting section 21 is pressed into the opening 11 of the specimen container 10. Thus, the periphery of the flange sections B (B1, B2) can liquid-tightly be pressed on the inner surface of the opening 11 of the specimen container 10.

In the stopper 20 according to the embodiment of the present invention, the flange sections B (B1, B2), which can be deformed greatly elastically, are formed at a fixed interval on the outer surface of the cylindrical body A. Therefore, even though the inside diameter of the opening 11 slightly differs from that of the regular-sized opening, the opening 11 can very liquid-tightly be sealed with the stopper 20 of the same size.

(Features of the Embodiment)

[1] A stopper 20 for tube-shaped specimen containers according to an embodiment of the present invention, comprises an inserting section 21 that is pushed into an opening 11 of a tube-shaped specimen container 10, a closing section 22 that continues with the inserting section 21 and has a flat surface H that is brought into intimate contact with a rim of the opening 11, and an operating section 23 that continues with the closing section 22 and operates to insert/remove the inserting section 21 into/from the opening 11. The stopper 20 is characterized in that the inserting section 21 is formed of an elastically-deformable liquid-tight member, and an annular flange section B is projected from an outer surface of a cylindrical body A such that a periphery of the annular flange section is liquid-tightly pressed on an inner surface of the opening 11 of the tube-shaped specimen container 10.

When the inserting section 21 of the stopper 20 is inserted into the opening 11 of the tube-shaped specimen container 10, the annular flange section B is compressed in the axial direction of the container 10 by the inner surface of the opening 11. Part of the cylindrical body A is also compressed and somewhat elastically deformed. Consequently, the periphery of the annular flange section B is liquid-tightly pressed on the inner surface of the opening 11. Concurrently with this, the flat surface H of the closing section 22 is brought into intimate contact with the rim of the opening 11. Therefore, the opening 11 of the specimen container 10 is liquid-tightly sealed in good condition.

[2] The stopper 20 for tube-shaped specimen containers according to above item [1] is characterized in that the annular flange section B is shaped like a parabolic antenna and have a tapered insertion end.

The annular flange section B is easy to insert into the opening 11 of the specimen container 10 and hard to remove therefrom. Thus, even when the stoppers of the same size are applied to specimen containers 10 whose openings 11 have somewhat different inside diameters, their consistency is improved.

[3] The stopper 20 for tube-shaped specimen containers according to above item [2] is characterized in that the annular flange section B has a plurality of notches V1 to V4 in a concave side thereof in a circumferential direction.

When the annular flange section B is pressed into the opening 11 of the tube-shaped specimen container 10, the notches V1 to V4 are narrowed by the compressive force received from the inner surface of the opening 11. Consequently, the outside diameter of the flange section B elastically varies with the inside diameter of the tube-shaped specimen container 10. Even though the outside diameter of the flange section B slightly differs from the inside diameter of the opening 11 (e.g., about ±0.5 to 1.0 mm), the opening 11 can liquid-tightly be sealed with the stopper 20. It was confirmed by experiment that a stopper whose annular flange section has an outside diameter of 10.5 mm could be used for both a specimen container whose opening has an inside diameter of 10 mm and a specimen container whose opening has an inside diameter of 11 mm without any trouble.

[4] The stopper 20 for tube-shaped specimen containers according to one of above items [1], [2] and [3] is characterized in that the annular flange section B includes a plurality of flange sections B1, B2 . . . that are projected at regular intervals.

The annular flange sections B1, B2 . . . fulfill a multiple function of preventing a leakage of liquid. When the stopper 20 is applied to specimen containers having different inside diameters, the lack of liquid-tightness can be compensated with the multiple function.

[5] The stopper 20 for tube-shaped specimen containers according to one of above items [1], [2], [3] and [4] is characterized in that the inserting section 21, the closing section 22 and the operating section 23 are formed of polypropylene resin integrally as one component.

The stopper 20, which is improved in elastic deformation, liquid tightness, chemical resistance, heat resistance, etc., can easily be manufactured.

What is claimed is:

1. A stopper for tube-shaped specimen containers, comprising an inserting section that is pushed into an opening of a tube-shaped specimen container, a closing section that continues with the inserting section and has a flat surface that is brought into intimate contact with a rim of the opening, and an operating section that continues with the closing section and operates to insert/remove the inserting section into/from the opening,
wherein the inserting section is formed of an elastically-deformable liquid-tight member, and an annular flange section is projected from an outer surface of a cylindrical body such that a periphery of the annular flange section is liquid-tightly pressed on an inner surface of the opening of the tube-shaped specimen container.

2. The stopper according to claim 1, wherein the annular flange section is shaped like a parabolic antenna and have a tapered insertion end.

3. The stopper according to claim 2, wherein the annular flange section has a plurality of notches in a concave side thereof in a circumferential direction.

4. The stopper according to claim 1, wherein the annular flange section includes a plurality of flange sections that are projected at regular intervals.

5. The stopper according to claim 2, wherein the annular flange section includes a plurality of flange sections that are projected at regular intervals.

6. The stopper according to claim 3, wherein the annular flange section includes a plurality of flange sections that are projected at regular intervals.

7. The stopper according to claim 3, wherein the inserting section, the closing section and the operating section are formed of polypropylene resin integrally as one component.
